(19) United States
(12) Patent Application Publication
(10) Pub. No.: US 2013/0323500 A1
(43) Pub. Date: Dec. 5, 2013

(54) FLAKED BOROSILICATE GLASS COATINGS

(71) Applicant: INSULATING COATINGS OF AMERICA, INC., Atlanta, GA (US)

(72) Inventors: Terrance McInerney, Atlanta, GA (US); Thomas Curtis, Decatur, GA (US)

(21) Appl. No.: 13/908,743

(22) Filed: Jun. 3, 2013

Related U.S. Application Data
(60) Provisional application No. 61/654,907, filed on Jun. 3, 2012.

(51) Int. Cl. C09D 5/26

(52) U.S. Cl. CPC C09D 5/26
USPC 428/325; 252/71

(57) ABSTRACT

A surface coated with a coating composition to form a coated surface is described. The coating composition includes a coating matrix and a quantity of flaked borosilicate glass. Upon exposure of the coated surface to sunlight or heat, the quantity of flaked borosilicate glass in the coating composition is effective such that the coated surface exhibits a cooler temperature than a temperature of a comparable uncoated surface, similarly exposed to sunlight or heat, but that does not comprise the coating composition.

### CROSS REFERENCE TO RELATED APPLICATIONS

This application claims priority to U.S. Provisional Patent Application No. 61/654,907 filed on Jun. 3, 2012, the disclosure of which is incorporated in full herein by reference.

### TECHNICAL FIELD

The present disclosure relates to coating compositions comprising flaked borosilicate glass.

### BACKGROUND

Historically, coatings have been utilized to protect an underlying material and/or to impart desirable surface properties, for example, color and/or gloss, thereto. Glass materials have also been added to coatings, such as paints, to impart fire resistant properties. For example, glass beads have been added to paints, such that when exposed to high heat or flame, the glass beads can melt and provide a flame resistant barrier. Glass materials, such as hollow glass spheres, have also been added to reduce the density of paints and coating materials.

It would be advantageous if a coating could impart other functional properties to a substrate or article, such as, for example, thermal management properties. These needs and other needs are satisfied by the compositions, methods, and products of the present disclosure.

### SUMMARY

In one aspect, a surface coated with a coating composition to form a coated surface is provided. The coating composition includes a coating matrix and a quantity of flaked borosilicate glass. Upon exposure of the coated surface to sunlight or heat, the quantity of flaked borosilicate glass in the coating composition is effective such that the coated surface exhibits a cooler temperature than a temperature of a comparable uncoated surface, similarly exposed to sunlight or heat, but that does not comprise the coating composition.

In another aspect, a method for cooling a surface is provided. The method includes applying a coating composition to the surface to form a coated surface. The coating includes a quantity of flaked borosilicate glass and a coating matrix. The coated surface is then exposed to sunlight or heat. Upon exposure of the coated surface to sunlight or heat, the quantity of flaked borosilicate glass in the coating composition is effective such that the coated surface exhibits a cooler temperature than a temperature of a comparable uncoated surface, similarly exposed to sunlight or heat, but that does not comprise the coating composition.

In still another aspect, a structure is provided. The structure includes a structural substrate with an exterior surface. A material layer is affixed to the exterior surface of the structural substrate. The material layer includes a first surface that is at least partially coated with a coating composition. The coating composition includes a quantity of flaked borosilicate glass. Upon exposure of the at least partially coated first surface to sunlight or heat, the quantity of flaked borosilicate glass in the coating composition is effective such that the at least partially coated first surface exhibits a cooler temperature than a temperature of a surface of a comparable uncoated material layer, similarly exposed to sunlight or heat, but that does not comprise the coating composition.

Additional aspects will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

These and other features, aspects, and advantages of the present disclosure will become better understood when the following detailed description is read with reference to the accompanying drawings.

FIG. 1 is a diagrammatical illustration of an exemplary wall structure in accordance with an embodiment of the present disclosure.

FIG. 2 is a diagrammatical illustration of an exemplary wall structure in accordance with an embodiment of the present disclosure.

FIG. 3 is a diagrammatical illustration of a roofing shingle, with an expanded view of the individual roofing components structure in accordance with an embodiment of the present disclosure.

FIG. 4 is a diagrammatical illustration of an example use of an exemplary roofing shingle in accordance with an embodiment of the present disclosure.

FIG. 5 is a diagrammatical illustration of an exemplary carbon nanotube structure that is coated with a coating composition in accordance with an embodiment of the present disclosure.

FIG. 6 is a diagrammatical illustration of an exemplary covered tent structure in accordance with an embodiment of the present disclosure.

FIG. 7 is a diagrammatical illustration of an exemplary two-walled structure in accordance with an embodiment of the present disclosure.

### DETAILED DESCRIPTION

Additional aspects will be set forth in part in the description that follows, and in part will be obvious from the description, or may be learned by practice of the aspects described below. The advantages described below will be realized and attained by means of the elements and combinations particularly pointed out in the appended claims. It is to be understood that the following detailed description is exemplary and explanatory only and is not restrictive.

In the following description, numerous specific details are given to provide a thorough understanding of embodiments. The embodiments can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment,” “an embodiment,” or “embodiments” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

All publications and patents mentioned in this disclosure are incorporated herein by reference in their entireties, for the purpose of describing and disclosing the constructs and methodologies described in those publications, which might be used in connection with the compositions and methods of this disclosure. Any publications and patents discussed above and throughout the text are provided solely for their disclosure prior to the filing date of the present application. Nothing herein is to be construed as an admission that the inventors are not entitled to antedate such disclosure by virtue of prior invention.

Unless indicated otherwise, when a range of any type is disclosed or claimed, it is intended to disclose or claim individually each possible number that such a range could reasonably encompass, including any sub-ranges encompassed therein. Moreover, when a range of values is disclosed or claimed, which Applicants intend to reflect individually each possible number that such a range could reasonably encompass, Applicants also intend for the disclosure of a range to reflect, and be interchangeable with, disclosing any and all sub-ranges and combinations of sub-ranges encompassed therein. Accordingly, Applicants reserve the right to proviso out or exclude any individual numbers or ranges, including any sub-ranges or combinations of sub-ranges within the group, if for any reason Applicants choose to claim less than the full measure of the disclosure, for example, to account for a reference that Applicants are unaware of at the time of the filing of the application.

Applicants further reserve the right to proviso out any selection, group, element, or aspect, for example, to limit the scope of any claim to account for a prior disclosure of which Applicants may be unaware.

The Abstract of this disclosure is provided for the purpose of satisfying the requirements of 37 C.F.R. §1.72 and the purpose stated in 37 C.F.R. §1.72(b) “to enable the United States Patent and Trademark Office and the public generally to determine quickly from a cursory inspection the nature and gist of the technical disclosure.” Therefore, the Abstract of this disclosure is not intended to be used to construe the scope of the claims or to limit the scope of the subject matter that is disclosed herein. Moreover, any headings that may be employed herein are also not intended to be used to construe the scope of the claims or to limit the scope of the subject matter that is disclosed herein.

### Coating Compositions

The coating compositions of the present disclosure comprise flaked borosilicate glass. In one aspect, the addition of a flaked borosilicate glass composition to a coating can improve the ability of the resulting coating to dissipate, move, and/or remove heat from an underlying substrate when exposed to sunlight or heat. The coating composition may provide improved thermal management properties, when applied to a substrate or a surface, as compared to a substrate or a surface without the coating composition. Without being bound to any one theory, the coating composition reduces the amount of thermal energy absorbed by the coated substrate or surface. In one aspect, a coated substrate or surface can remain at about ambient temperature upon exposure to thermal radiation, for example, solar, infrared, convective, or a combination thereof. In another aspect, the coating composition may reduce the amount of thermal radiation absorbed by an underlying substrate or surface. In another aspect, upon exposure to sunlight or heat, the portion of a substrate or a surface comprising the coating composition may exhibit a temperature that is about 5° F. to about 50° F., about 10° F. to about 40° F., about 15° F. to about 30° F., about 20° F. to about 30° F., or about 25° F. cooler than a comparable uncoated substrate or surface.

The coating composition of the present disclosure comprises a coating matrix and an effective amount of flaked borosilicate glass. As used herein, the term “coating composition” is intended to refer to a mixture of coating components, such as, for example, flaked borosilicate glass and a vehicle and/or resin system, prior to drying and/or curing to form a coating. As used herein, “coating matrix” refers to any other components that are present in a cured and/or dried form of the coating composition, and may comprise anything except the flaked borosilicate glass. Similarly, the terms “coated,” “coating” and “coated surface” are intended to refer to a cured and/or dried form of the coating compositions. It should be understood that a coating formed from a coating composition will typically comprise the same components as the coating composition, except for any volatile components that can evaporate, and/or any components that cross-link or react with other components, a substrate, or a combination thereof.

In some embodiments, the coating compositions may improve the thermal properties of the coated surface or coated structure, relative to a comparable uncoated surface or uncoated structure. In an embodiment, the coating compositions are, upon exposure to heat, sunlight, or solar radiation, effective to impart a thermal emittance in the range of about 0.5 and about 0.95, about 0.5 and about 0.85, about 0.5 and about 0.75, about 0.6 to about 0.75, or about 0.65 to about 0.75. In some embodiments, the coating compositions are effective to impart an R-value (thermal insulation) in the range of about 0.10 to about 10, about 0.1 to about 6, about 0.1 to about 3, about 0.1 to about 1, or about 0.1 to about 0.5.

In some embodiments, the coating compositions, upon exposure to sunlight or heat, comprise a coated surface that has a radiative emittance in a wavelength range of about 15 μm to about 1000 μm to emit thermal energy in the wavelength range. are effective to impart a radiative emittance and to emit thermal radiation in a wavelength in the range of about 0.1 μm to about 1000 μm, about 15 μm to about 1000 μm, about 1 μm to about 500 μm, about 5 μm to about 250 μm, about 10 μm to about 100 μm, about 10 μm to about 50 μm, about 10 μm to about 25 μm, about 10 μm to about 20 μm, or about 8 μm to about 15 μm. In other embodiments, the coating compositions are effective such that absorbed incident infrared, solar, or heat radiation is radiatively emitted from the coating composition (and coated surface or coated structure) at a lower energy than the absorbed incident radiation.

In certain embodiments, the coating composition, after drying and/or curing, consists essentially of a coating matrix and a flaked borosilicate glass.

In one embodiment, a surface coated with a coating composition to form a coated surface is provided. In embodiments, the surface includes, but is not limited to, roofing shingles, roofing granules, and/or carbon nanotubes. Upon exposure of the coated surface to sunlight or heat, the quantity of flaked borosilicate glass in the coating composition is effective such that the coated surface exhibits a cooler temperature than a temperature of a comparable uncoated surface, similarly exposed to sunlight or heat, but that does not comprise the coating composition.

In some embodiments, the coating composition applied to a surface or a substrate forms a coated surface or coated substrate with a low amount of solar reflectance. In some embodiments, the amount of solar reflectance is less than about 50%, less than about 40%, less than about 30%, or less than about 20%. In other embodiments, the amount of solar reflectance is in the range of about 20% to about 50%, about 30% to about 50%, about 40% to about 50%, or about 50%. In still other embodiments, the amount solar reflectance of a coated substrate or a coated surface may be the same amount of solar reflectance as a comparable uncoated substrate or uncoated surface, respectively.

In some embodiments, the coating matrix may comprise a paint, such as, for example, a latex paint, an alkyl paint, an acrylic paint, or a combination thereof. In a specific embodiment, the coating matrix comprises a latex paint. In other aspects, the coating matrix may comprise an epoxy, an elastomeric material, or a crosslinkable material. In other aspects, the coating matrix may comprise other resin systems or components that can for a coating upon, for example, curing and/or drying.

In one aspect, the coating matrix does not comprise a pyrolyzed carbon containing ionic species. In still other aspects, the coating matrix does not comprise one or more of a clay, a binder material, or a combination thereof. In yet another aspect, the coating matrix does not comprise a silicone and/or cross-linkable silicone component, such as, for example, an organosilicone. In another aspect, the coating matrix and/or the resulting coating composition is not a cosmetic composition that can be applied to, for example, a living tissue. In another aspect, the coating matrix is not an insulation paste, such as, for example, an electrical insulation paste that is designed to be used in an electrical circuit or device.

The coating compositions of the present disclosure include an effective quantity of flaked borosilicate glass. In various aspects, the coating composition is configured to provide thermal management properties to an underlying substrate. In various aspects, the flaked borosilicate composition can comprise one or more of the following: boron, silica, alumina, calcium oxide, potassium and/or sodium oxides, lead, or a combination thereof. In another aspect, the flaked borosilicate composition does not comprise lead. In yet another aspect, the flaked borosilicate composition does not comprise a heavy metal. It should be understood that the composition of a flaked borosilicate glass may vary, and that the specific compositions of any particular flaked borosilicate composition may comprise other items not specifically recited herein.

In one aspect, the flaked borosilicate glass comprises boron. In some embodiments, the flaked borosilicate glass may comprise boron in a concentration from about 20 wt. % to about 50 wt. % of the flaked borosilicate glass, from about 30 wt. % to about 50 wt. % of the flaked borosilicate glass, from about 20 wt. % to about 40 wt. % of the flaked borosilicate glass, from about 30 wt. % to about 40 wt. % of the flaked borosilicate glass, or about 35 wt. % of the flaked borosilicate glass.

In another aspect, the flaked borosilicate glass comprises silica. In some embodiments, the flaked borosilicate glass may comprise silica in a concentration from about 30 wt. % to about 70 wt. % of the flaked borosilicate glass, from about 30 wt. % to about 60 wt. % of the flaked borosilicate glass, from about 20 wt. % to about 50 wt. %, from about 40 wt. % to about 70 wt. % of the flaked borosilicate glass, from about 30 wt. % to about 50 wt. % of the flaked borosilicate glass, from about 50 wt. % to about 70 wt. % of the flaked borosilicate glass, from about 40 wt. % to about 60 wt. % of the flaked borosilicate glass, or about 50 wt. % of the flaked borosilicate glass.

In another aspect, the flaked borosilicate glass comprises alumina. In some embodiments, the flaked borosilicate glass may comprise alumina in a concentration from about 0 wt. % to about 2 wt. % of the flaked borosilicate glass, from about 0.01 wt. % to about 1 wt. %, from about 0.01 wt. % to about 0.05 wt. %, from about 0.01 wt. % to about 0.1 wt %, from about 0.1 wt % to about 0.5 wt. %, from about 0.5 wt. % to about 2 wt. % of the flaked borosilicate glass, from about 0.5 wt. % to about 1.5 wt. % of the flaked borosilicate glass, or about 1.0 wt. % of the flaked borosilicate glass. In another aspect, the flaked borosilicate glass comprises an alumina concentration of greater than 2 wt. % of the flaked borosilicate glass. In other embodiments, the flaked borosilicate glass does not comprise alumina.

In another aspect, the flaked borosilicate glass comprises calcium oxide. In some embodiments, the flaked borosilicate glass may comprise calcium oxide in a concentration from about 0 wt. % to about 5 wt. % of the flaked borosilicate glass, from about 0.01 wt. % to about 5 wt. %, from about 0.01 wt. % to about 1 wt. %, from about 0.01 wt. % to about 0.1 wt. %, from about 0.01 wt. % to about 0.5 wt. %, from about 0.1 wt. % to about 0.5 wt. %, from about 0 wt. % to about 4 wt. % of the flaked borosilicate glass, from about 1 wt. % to about 4 wt. % of the flaked borosilicate glass, from about 0 wt. % to about 3 wt. % of the flaked borosilicate glass, from about 1 wt. % to about 3 wt. % of the flaked borosilicate glass, from about 1 wt. % to about 2 wt. % of the flaked borosilicate glass, or about 2.5 wt. % of the flaked borosilicate glass. In still another aspect, the flaked borosilicate glass comprises a calcium oxide concentration of greater than about 5 wt. % of the flaked borosilicate glass. In other embodiments, the flaked borosilicate glass does not comprise calcium oxide.

In another aspect, the flaked borosilicate glass comprises potassium oxide. In some embodiments, the flaked borosilicate glass may comprise potassium oxide in a concentration from about 0 wt. % to about 15 wt. % of the flaked borosilicate glass, from about 0 wt. % to about 10 wt. % of the flaked borosilicate glass, from about 0.01 wt. % to about 1 wt. %, from about 0.01 wt. % to about 0.1 wt. %, from about 0.1 wt. % to about 0.5 wt. %, from about 5 wt. % to about 15 wt. % of the flaked borosilicate glass, from about 5 wt. % to about 10 wt. % of the flaked borosilicate glass, from about 10 wt. % to about 15 wt. % of the flaked borosilicate glass, from about 0 wt. % to about 5 wt. % of the flaked borosilicate glass, or about 7.5 wt. % of the flaked borosilicate glass. In still another aspect, the flaked borosilicate glass comprises a potassium oxide concentration of greater than about 15 wt. % of the flaked borosilicate glass. In other embodiments, the flaked borosilicate glass does not comprise potassium oxide.

In another aspect, the flaked borosilicate glass comprises sodium oxide. In some embodiments, the flaked borosilicate glass may comprise sodium oxide in a concentration from about 0 wt. % to about 15 wt. % of the flaked borosilicate glass, from about 0 wt. % to about 10 wt. % of the flaked borosilicate glass, from about 0.01 wt. % to about 1 wt. %, from about 0.01 wt. % to about 0.1 wt. %, from about 0.1 wt. % to about 0.5 wt. %, from about 5 wt. % to about 15 wt. % of the flaked borosilicate glass, from about 5 wt. % to about 10 wt. % of the flaked borosilicate glass, from about 10 wt. % to about 15 wt. % of the flaked borosilicate glass, from about 0 wt. % to about 5 wt. % of the flaked borosilicate glass, or about 7.5 wt. % of the flaked borosilicate glass. In still another aspect, the flaked borosilicate glass comprises a sodium oxide concentration of greater than about 15 wt. % of the flaked borosilicate glass. In other embodiments, the flaked borosilicate glass does not comprise sodium oxide.

In another aspect, the flaked borosilicate glass comprises lead. In some embodiments, the flaked borosilicate glass may comprise lead in a concentration from about 0 wt. % to about 15 wt. % of the flaked borosilicate glass, from about 0 wt. % to about 10 wt. % of the flaked borosilicate glass, from about 0.01 wt. % to about 1 wt. %, from about 0.01 wt. % to about 0.1 wt. %, from about 0.1 wt. % to about 0.5 wt. %, from about 5 wt. % to about 15 wt. % of the flaked borosilicate glass, from about 5 wt. % to about 10 wt. % of the flaked borosilicate glass, from about 10 wt. % to about 15 wt. % of the flaked borosilicate glass, from about 0 wt. % to about 5 wt. % of the flaked borosilicate glass, or about 7.5 wt. % of the flaked borosilicate glass. In still another aspect, the flaked borosilicate glass comprises a lead concentration of greater than about 15 wt. % of the flaked borosilicate glass. In other embodiments, the flaked borosilicate glass does not comprise lead.

In one aspect, the flaked borosilicate glass can comprise a varying morphology, such as, for example, can occur from crushing and/or grinding a flaked borosilicate glass composition. In one aspect, at least a portion of the flaked borosilicate glass comprises a flake morphology. In another aspect, at least a portion of the flaked borosilicate glass comprises a needle morphology. In yet another aspect, at least a portion of the individual particles of the flaked borosilicate glass are flat or substantially planar. In other aspects, the morphology of all or a portion of the flaked borosilicate glass particles is irregular and can vary from at least another portion of the flaked borosilicate glass particles. In another aspect, all or substantially all of the flaked borosilicate glass comprises a flaked morphology.

In one aspect, the flaked borosilicate glass does not comprise glass spheres, glass micro spheres, or combinations thereof. In another aspect, the flaked borosilicate glass does not comprise a plurality of irregular shaped particles as can occur from crushing and/or grinding a flaked borosilicate glass composition. In yet another aspect, the flaked borosilicate glass is not intended to impart a reflective property to the resulting coatings. In still other aspects, the flaked borosilicate glass does not comprise a coating of iron oxide, titania, rutile titanium dioxide, silver, or a combination thereof. In yet another aspect, the flaked borosilicate glass is not designed or intended to melt and form a flame resistant barrier upon exposure to heat. In yet another embodiment, the flaked borosilicate composition does not comprise an endothermic heat consuming compound, including but limited to inorganic salts that may undergo conformational changes and/or dehydration upon exposure to thermal energy.

In one aspect, the flaked borosilicate glass is particulate, wherein at least a portion of the particles have an average size in at least one dimension of from about 5 micrometers to about 100 micrometers, about 5 micrometers to about 50 micrometers, about 5 micrometers to about 25 micrometers, from about 5 micrometers to about 10 micrometers, from about 50 to about 100 micrometers, or about 50 micrometers. In still other aspects, at least a portion of the flaked borosilicate glass particles can have an average size in at least one dimension of less than about 5 micrometers or greater than about 100 micrometers. Moreover, it should be understood that the size of glass particles is a distributional property and that the average and standard deviation for a particular batch of particles may vary.

In one aspect, at least a portion of the flaked borosilicate glass particles can have an aspect ratio of from about 0.01:1 to about 0.1:1, from about 1:1 to about 1000:1, from about 1:1 to about 500:1, from about 1:1 to about 250:1, from about 1:1 to about 100:1, or from about 1:1 to about 10:1. In other aspects, the aspect ratio of at least a portion of the glass particles can be greater than about 1000:1. In another aspect, the aspect ratio of at least half of the glass particles is greater than about 100:1. In yet another aspect, the aspect ratio of all or substantially all of the glass particles is at least about 100:1.

The coating composition may comprise any formulation that can provide a desired final coating. In various aspects, the coating composition can comprise one or more of: rheological aids, water, de-ionized water, pH buffers, binding agents, plasticizers, surfactants, pigments, dyes, defoaming agents, and combinations thereof

The amount of flaked borosilicate glass present in a coating composition can be any amount suitable for the intended application. In one aspect, the amount of flaked borosilicate glass present in a coating composition can be an amount sufficient to impart desirable thermal properties to the resulting coated surface. In another aspect, the amount of flake borosilicate glass present in a coating composition can be an amount that does not adversely affect the mechanical properties of the resulting coated surface.

In another aspect, the amount of flaked borosilicate glass present in the coating composition, for example, before curing and/or drying, can comprise from about 5 wt. % to about 50 wt. %, about 5 wt. % to about 40 wt. %, about 5 wt. % to about 30 wt. %, about 5 wt. % to about 20 wt. %, about 5 wt. % to about 10 wt. %, about 10 wt. % to about 50 wt. %, about 10 wt. % to about 40 wt. %, about 10 wt. % to about 30 wt. %, about 10 wt. % to about 20 wt. %, about 10 wt. % to about 15 wt. %, about 20 wt. % to about 50 wt. %, about 20 wt. % to about 40 wt. %, about 20 wt. % to about 30 wt. %, about 30 wt. % to about 50 wt. %, about 30 wt. % to about 40 wt. %, or about 35 wt. % of the concentration by unit weight of the resulting undried coating composition. In other aspects, the amount of flaked borosilicate glass present in the undried coating composition can be less than about 5 wt. % or greater than about 50 wt. %.

In another aspect, the amount of flaked borosilicate glass present in the coating composition, for example, after curing and/or drying, can comprise from about 10 wt. % to about 80 wt. %, about 10 wt. % to about 70 wt. %, about 10 wt. % to about 60 wt. %, about 10 wt. % to about 60 wt. %, about 10 wt. % to about 50 wt. %, about 10 wt. % to about 40 wt. %, about 10 wt. % to about 30 wt. %, about 10 wt. % to about 20 wt. %, about 10 wt. % to about 15 wt. %, about 20 wt. % to about 80 wt. %, about 30 wt. % to about 80 wt. %, about 40 wt. % to about 80 wt. %, about 50 wt. % to about 80 wt. %, about 60 wt. % to about 80 wt. %, about 70 wt. % to about 80 wt. %, about 25 wt. % to about 65 wt. %, about 30 wt. % to about 60 wt. %, about 30 wt. % to about 50 wt. %, or about 45 wt. % of the concentration by unit weight of the resulting coating composition. In other aspects, the amount of glass particles present in the resulting coating composition can be less than about 10 wt. % or greater than about 80 wt. %.

In one aspect, the coating composition, once applied, can have a thickness of about 1 mil to about 8 mil, about 2 mil to about 8 mil, about 3 mil to about 8 mil, about 4 mil to about 8 mil, about 5 mil to about 8 mil, about 6 mil to about 8 mil, about 7 mil to about 8 mil, about 2 mil to about 6 mil, about 2 mil to about 4 mil, or about 3 mil. In still other aspects, the thickness of a coating composition, once applied, can be less than about 1 mil or greater than about 8 mil. In one aspect, the thickness of a coating composition can be thicker than about 8 mil to improve, for example, mechanical properties and/or the durability of the resulting coated material or surface.

Additional details of the coating compositions, including features of the flaked borosilicate glass and the coating matrix, may be found in the related U.S. Non-Provisional patent application Ser. No. 13/040,932, filed Mar. 4, 2011, the entire subject matter of which is expressly incorporated herein by reference.

### Coated Structures

In an embodiment, a structure including a structural substrate and a material layer is provided. The material layer is affixed to the structural substrate. The material layer may comprise a first surface that is at least partially coated with a coating composition. The coating composition includes an effective amount of flaked borosilicate glass. Upon exposure of the at least partially coated first surface to sunlight or heat, the quantity of flaked borosilicate glass in the coating composition is effective such that the at least partially coated first surface exhibits a cooler temperature than a temperature of a surface of a comparable uncoated material layer, similarly exposed to sunlight or heat, but that does not comprise the coating composition.

The coating compositions used for the coated material layer, including the degree of surface cooling, the amount of solar reflectance, and the quantity of flaked borosilicate glass in the coating compositions are the same as described above. The coating compositions used for the coated material layer may also comprise any of the other properties described above for coating compositions comprising flaked borosilicate glass.

In one embodiment, the substrate is a wall structure that may include a first material layer and a second material layer. The second layer may comprise a coating composition, as described above. The wall structure may further comprise an adjustable spacing system, in some instances an external tent frame, that may be configured to provide an adjustable distance between the first material layer and the second material layer. In some embodiments, a suitable distance between the first layer and the second layer is about 0.0001 inches to about 8 inches, about 0.0001 inches to about 1 inch, about 0.0001 inches to about 0.1 inches, about 0.0001 inches to about 0.01 inches, about 0.0001 inches to about 0.001 inches, about 0.1 inches to about 8 inches, about 0.5 inches to about 6 inches, about 0.5 inches to about 4 inches, or about 1.0 inch to 4 inches.

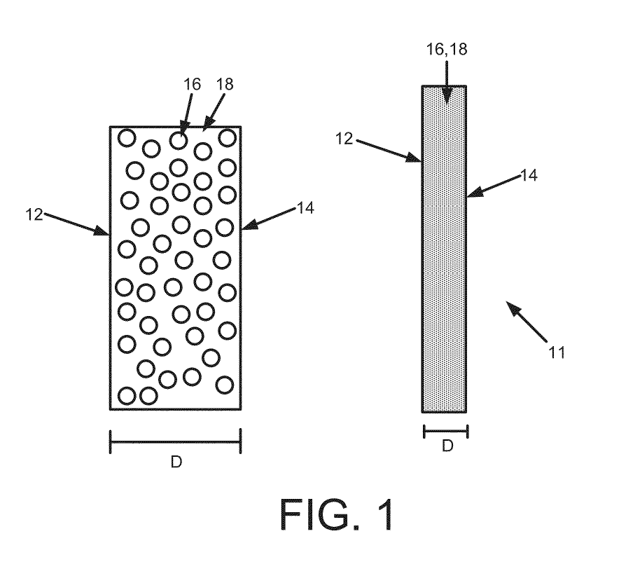

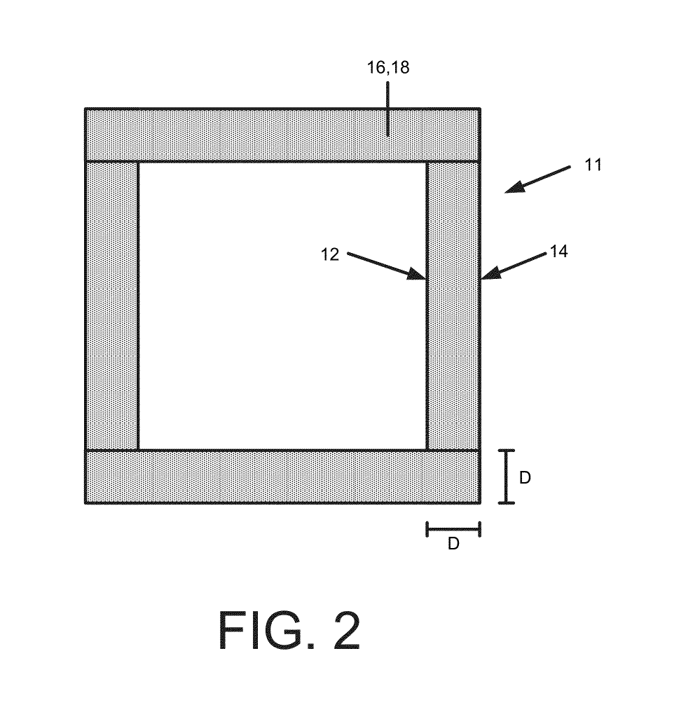

Examples of such a wall structure are shown in FIGS. 1 and 2. In FIG. 1, the wall structure comprises a first material layer (12) and a second material layer (14). The space between the material layers (12, 14) is designated as the distance D. As shown in FIG. 1, in some embodiments the space between the layers (12, 14) may be filled with a desiccant (16) and a gas (18). In FIG. 1, the exterior surface of the second material layer (14) is configured to be at least partially coated with the coating composition described herein and may be exposed to sunlight or heat.

In an alternate embodiment, FIG. 2 shows an enclosed wall structure. The enclosed wall structure comprises a first material layer (12) that may be configured to be an interior wall of the structure. The enclosed wall structure further comprises a second material layer (14) that may be configured as an exterior wall of the structure. The space between the first material layer (12) and the second material layer (14) may be filled with a desiccant (16) and a gas (18), while the structural substrate is the wall. In FIG. 2, the coated surface of the second material layer (14) is exposed to sunlight or heat. In some embodiments, the interior temperature of the structure shown in FIG. 2 is at least about 5° F. cooler than the interior temperature of a comparable structure that does not comprise the second material layer (14), the desiccant (16), and/or the gas (18).

In some embodiments, the coating composition may be applied to at least a portion of a surface of a material layer to form a coated portion of the material layer. When the coated portion of the material layer is exposed to sunlight or heat, the temperature of the coated portion of the material layer remains cooler than the temperature of an uncoated portion of the material layer that is exposed to the same sunlight or heat. As used herein, the term “comparable” refers to a material layer that does not comprise the coating composition. In another example, the comparable surface is a surface of a material layer that does not comprise the coating composition, but that is otherwise substantially similar to the material layer that does comprise the coating composition.

In other embodiments, the surface of the material layer that comprises a coating composition and that is exposed to sunlight or heat exhibits a temperature of at least about 5° F. cooler than a comparable surface of an uncoated material layer. As described above, the coating composition may provide other thermal management properties based on the composition of the coating composition.

In another embodiment, the wall structure may further comprise a void or empty space between the first material layer and the second material layer. The size of this void or empty space may be adjusted by adjusting the distance between the first material layer and the second material layer, as described above. In some embodiments, the void may comprise at least one gas and at least one desiccant. Suitable gases include inert gases, including but not limited to argon, nitrogen, helium, and combinations thereof. In some embodiments, one or more inert gases may be mechanically produced using a device configured to deliver the inert gas from the atmosphere into the void. In some embodiments, the void may comprise at least on desiccant, including but not limited to silica gel, alumina, activated charcoal, calcium oxide, calcium sulfate, magnesium sulfate, calcium chloride, montmorillonite clay, molecular sieves, zeolites, and combinations thereof

In still other embodiments, the void in the wall structure may comprise an inflatable gas chamber. In some embodiments, the inflatable gas chamber may be filled with at least one gas and/or at least one desiccant. In other embodiments, the inflatable air chamber may already include an internal desiccant and have a valve that allows one or more gases to be introduced into the inflatable air chamber by a user or an automated system.

In some embodiments, the first material layer and the second material layer comprise the same type of material. In other embodiments, the first material layer and the second material layer each comprise a separate type of material. In some embodiments, the first material layer, the second material layer, or both comprise a woven fabric. In some embodiments, the first material layer, the second material layer, or both comprise a nonwoven fabric. In some embodiments, the first material layer, the second material layer, or both comprise a moldable thermoplastic fabric. In some embodiments, the first material layer, the second material layer, or both comprise a polymeric material. Similarly, in embodiments with a single material layer, the material layer may comprise any of the above-identified materials.

In another embodiment, a method for reducing the temperature of a structure that is exposed to sunlight or heat is provided. The method comprises providing a first material layer and a second material layer. A coating composition is applied to at least a portion of the second material layer of the structure to form a coated structure. The coating composition comprises a coating matrix and an effective quantity of flaked borosilicate glass. The coated structure is then exposed to sunlight or heat and the temperature of an interior space of the coated structure is lower than a comparable interior space of an uncoated structure, similarly exposed to sunlight or heat, but that does not comprise the coating composition. In some embodiments, the temperature of the interior space of the coated structure is at least about 5° F. cooler than the temperature of the comparable structure that does not comprise the coating composition. As described above, the coating composition may provide other thermal management properties based on the chemical make-up of the applied coating composition.

In another embodiment, a method for preparing a structure is provided. The method comprises providing both a first material layer and a second material layer for the structure. A coating composition, comprising a coating matrix and an effective quantity of flaked borosilicate glass, may then be applied to at least a portion of the second material layer. In some embodiments, the distance between the first material layer and the second material layer may be adjusted, either manually or automatically.

In some embodiments, the structure may be exposed to sunlight or heat. The temperature of the at least a portion of the second material layer that comprises the coating composition remains cooler than a comparable uncoated second material layer, similarly exposed to sunlight or heat, that does not comprise the coating composition. In some embodiments, the temperature of the at least a portion of the second material layer comprising the coating composition is at least about 5° F. cooler than the temperature of the comparable uncoated second material layer. As described above, the coating composition may provide other thermal management properties based on the composition of the coating composition.

In some embodiments, at least one gas and at least one desiccant may be inserted between the first material layer and the second material layer. The at least one gas and the at least one desiccant may be added together or individually. In some embodiments, an inflatable inner tube or gas chamber comprising at least one desiccant may be inserted between the first material layer and the second material layer. In other embodiments, at least one gas may be inserted into the inflatable inner tube.

### Coated Roofing Shingles

In another embodiment, a roofing shingle is provided. In some embodiments, the roofing shingle has a surface with a coating composition that forms a coated surface. The roofing shingle may comprise a roofing substrate and a plurality of granules that are secured to the roofing substrate. At least one of the substrate or the plurality of granules is at least partially covered with the coating composition. The coating composition may be applied to at least a portion of a surface of the plurality of granules to form one or more coated granules. When the coated granules are exposed to sunlight or heat, the temperature of the one or more coated granules remains cooler than a comparable granule, that does not comprise the coating composition, but that is similarly exposed to sunlight or heat. In some embodiments, the one or more coated granules that are exposed to sunlight or heat exhibit a temperature of at least about 5° F. cooler than the comparable uncoated granule. As described above, the coating composition may provide other thermal management properties based on the configuration of the coating composition.

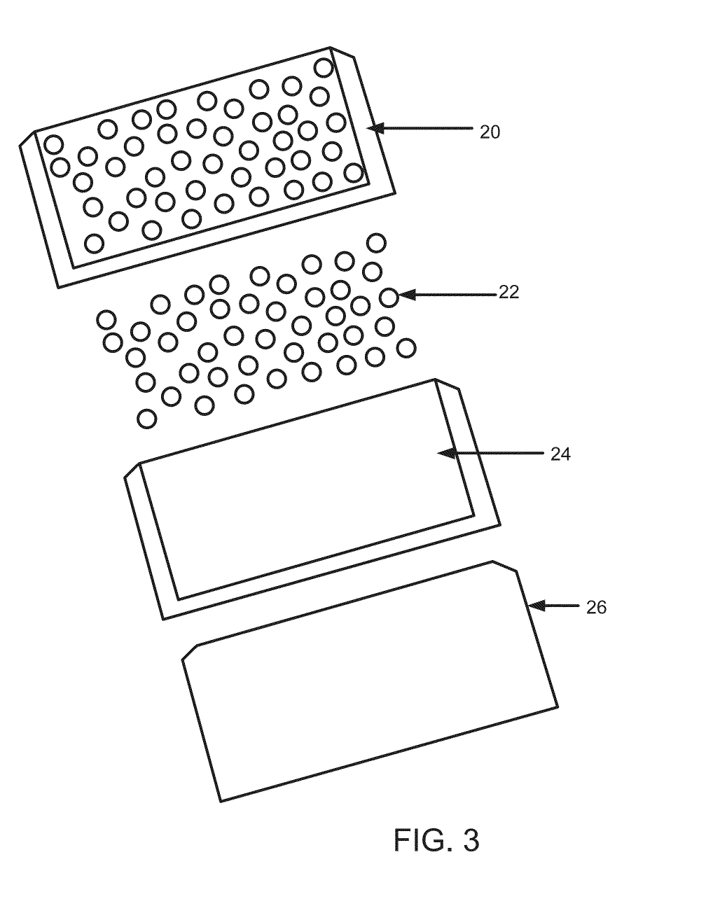

FIG. 3 shows an exemplary roofing shingle (20) and a detailed view of each of the individual components (granules (22), roofing substrate (24), and roofing paper (26)) of the roofing shingle (20). The coating composition described herein may be applied to or used to coat one or more of the granules (22), the roofing substrate (24), the roofing paper (26), or any combination of these individual components.

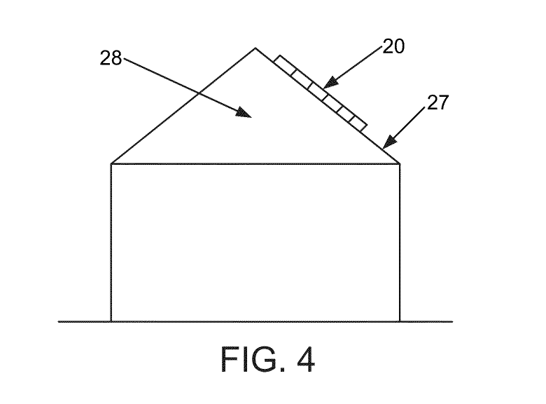

In some embodiments, the roofing shingle (20) may be applied to the exterior surface of a roof. As shown in FIG. 4, the exterior surface (27) of the roof may be coated with roofing shingles (20). In some embodiments, the roofing shingles (20) may be configured for exposure to sunlight or heat. In such embodiments, the internal temperature of the attic space (28) beneath the roof comprising the coated roofing shingles (20) is at least 5° F. cooler than the internal temperature of a comparable attic space (28) beneath a comparable roof that does not comprise the coated roofing shingles described herein.

In an embodiment, a roofing shingle is provided wherein the roofing substrate is at least partially covered with the coating composition. The coating composition may be applied to at least a portion of a surface of the roofing substrate to form a coated substrate surface. When the coated substrate surface is exposed to sunlight or heat, the temperature of the coated substrate surface remains cooler than a comparable uncoated substrate surface that does not comprise the coating composition but that is similarly exposed to sunlight or heat. In some embodiments, the coated substrate surface that is exposed to sunlight or heat exhibits a temperature of at least about 5° F. cooler than a comparable uncoated substrate surface. As described above, the coating composition may provide other thermal management properties based on the composition of the coating composition.

In still other embodiments, the roofing shingle may further comprise a roofing film that may be attached to the roofing substrate. In some embodiments, the roofing film may comprise the coating composition. In particular embodiments, the roofing film is at least partially coated with the coating composition to form a coated roofing film. When the coated roofing film is exposed to sunlight or heat, the temperature of the coated roofing film remains cooler than a comparable uncoated roofing film, that does not comprise the coating composition, but that is similarly exposed to sunlight or heat. In some embodiments, the coated roofing film that is exposed to sunlight or heat exhibits a temperature of at least about 5° F. cooler than a comparable uncoated roofing film. As described above, the coating composition may provide other thermal management properties based on the composition of the coating composition.

In still other embodiments, a roofing shingle may comprise one or more of the coated components discussed above, including a roofing film, coated granules, a coated roofing substrate, and/or a coated roofing paper. In other embodiments, a roofing shingle may further comprise a coated carbon material, as described in detail below. In embodiments, the coated carbon material may be used with a standard roofing shingle. In still other embodiments, the coated carbon material may be used with a roofing shingle comprising one or more of the coated granules, the coated roofing substrate, and/or the coated roofing paper.

In another embodiment, a method for reducing the temperature of a roofing shingle exposed to sunlight or heat is provided. The method comprises providing a roofing substrate, a backing paper, and securing a plurality of granules to the roofing substrate. A coating composition may then be applied to at least one of the substrate, the plurality of granules, or the backing paper. The coating composition comprises a coating matrix and a quantity of flaked borosilicate glass, as described in detail above. The coated substrate, granules, or backing paper may then be exposed to sunlight or heat, and the coated substrate, granules, or backing paper exhibit a cooler temperature than comparable uncoated substrate, uncoated granules, or uncoated backing paper that is exposed to similar sunlight or heat. In some embodiments, the temperature of the coated roofing component is at least about 5° F. cooler than the temperature of the comparable uncoated roofing component. As described above, the coating composition may provide other thermal management properties based on the composition of the coating composition.

In another embodiment, a method for preparing a roofing shingle is provided. The method comprises providing a roofing substrate and securing a plurality of granules to the substrate. In a final step, a coating composition is applied to at least one of the roofing substrate and/or the plurality of granules. The coating composition comprises a coating matrix and an effective quantity of flaked borosilicate glass, as described in detail above.

In some embodiments, the step of applying the coating composition to the shingle component comprises applying the coating composition to at least a portion of a surface of the plurality of granules to form one or more coated granules. The one or more coated granules may then be exposed to sunlight or heat, and the one or more coated granules remain at a cooler temperature than a comparable granule, similarly exposed to sunlight or heat, that does not comprise the coating composition. In some embodiments, the temperature of the one or more coated granules is at least about 5° F. cooler than the temperature of the comparable uncoated granules. As described above, the coating composition may provide other thermal management properties based on the chemical make-up of the applied coating composition.

In some embodiments, the step of applying the coating composition to the shingle component comprises applying the coating composition to at least a portion of a surface of the roofing substrate to form a coated substrate. The coated substrate may then be exposed to sunlight or heat, and the coated substrate remains at a cooler temperature than a comparable uncoated substrate, similarly exposed to sunlight or heat, that does not comprise the coating composition. In some embodiments, the temperature of the coated substrate is at least about 5° F. cooler than the temperature of the comparable uncoated substrate. As described above, the coating composition may provide other thermal management properties based on the chemical make-up of the applied coating composition.

In some embodiments, a commercially available roofing shingle may be coated with the coating composition. In such embodiments, various components of the commercial roofing shingle may be covered with the coating composition, including but not limited to the granules, roofing substrate, and/or backing paper of the roofing shingle. In still other embodiments, a coating composition may be applied to existing roofing shingles that have already been installed on the roof of a structure. As discussed in detail below, a commercial roofing shingle may also incorporate a coated carbon material.

### Coated Carbon Materials

In another embodiment, a carbon substrate is provided as a surface. Carbon substrates may include, but are not limited to, carbon fibers, carbon nanotubes, carbon nanoplates, molecular carbon, graphene, single-walled nanotubes, multi-walled nanotubes, and combinations thereof. A coating composition is disposed on at least one surface of the at least one carbon substrate to form a coated carbon material. The coating composition, as described above, comprises a coating matrix and an effective quantity of flaked borosilicate glass.

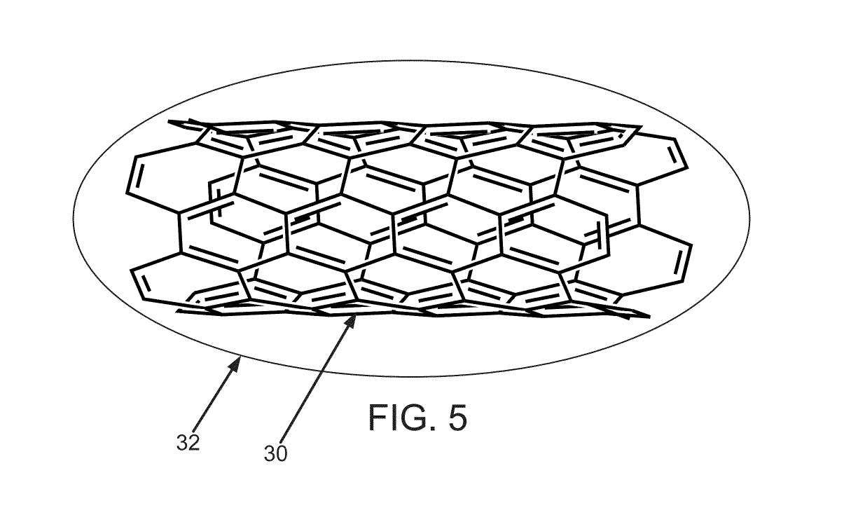

FIG. 5 shows an embodiment where the exterior surface of a carbon nanotube (30) is substantially coated with the coating composition (32). In other embodiments, only portions of the carbon nanotube (30) or portions of another carbon substrate may be coated and/or impregnated with the coating composition (32).

In some embodiments, the coated carbon material, when exposed to sunlight or heat, remains cooler than a comparable carbon material, similarly exposed to sunlight or heat, that does not comprise the coating composition. In some embodiments, the temperature of the coated carbon material is at least about 5° F. cooler than the temperature of the comparable uncoated carbon material. As described above, the coating composition may provide other thermal management properties based on the chemical make-up of the coating composition.

In another embodiment, a method for reducing the temperature of a coated carbon material that is exposed to sunlight or heat is provided. The method comprises providing at least one carbon substrate and disposing a coating composition on at least one surface of the at least one carbon substrate to form a coated carbon material. The coating composition comprises a coating matrix and an effective quantity of flaked borosilicate glass. The coated carbon material is then exposed to sunlight or heat and the coated carbon material exhibits a cooler temperature than a comparable uncoated carbon substrate that is similarly exposed to sunlight or heat. In some embodiments, the temperature of the coated carbon material is at least about 5° F. cooler than the temperature of the comparable uncoated carbon material. As described above, the coating composition may provide other thermal management properties based on the chemical make-up of the applied coating composition.

In another embodiment, a method for preparing a coated carbon material is provided. At least one carbon substrate is provided and a coating composition is disposed on at least one surface of the carbon substrate. The coating composition comprises a coating matrix and an effective amount of flaked borosilicate glass. In some embodiments, the coated carbon material is exposed to sunlight or heat. The coated carbon material exhibits a cooler temperature than a comparable carbon substrate, similarly exposed to sunlight or heat, that does not comprise the coating composition. In some embodiments, the temperature of the coated carbon material is at least about 5° F. cooler than the temperature of the comparable uncoated carbon substrate. As described above, the coating composition may provide other thermal management properties based on the chemical make-up of the applied coating composition.

In some embodiments, the coated carbon material may be applied to the surface of other substrates. In some embodiments, the carbon material initially may be covered with the coating composition such that the coated portion of the coated carbon material is configured for direct exposure to sunlight or heat. In some embodiments, the coated carbon material may be applied to the exterior surface of a structure, such that the interior of the structure is at least about 5° F. cooler than the temperature of a comparable interior of a comparable structure that does not comprise a coated carbon material on a comparable exterior surface of a comparable structure.

In other embodiments, the carbon substrate may be covered with the coating composition such that the coated portion of the coated carbon material, when applied to the surface of a building, is not directly exposed to sunlight or heat. In still other embodiments, the carbon substrate may be coated with the coating composition such that the coated surface of the coated carbon material faces away from direct exposure to sunlight or heat. In some embodiments, the coated carbon material may be applied to an exterior surface with the coated surface facing away from the direct exposure to sunlight or heat, such that the interior of the structure is at least about 5° F. cooler than the temperature of a comparable interior of a comparable structure that does not comprise a comparably coated carbon material on the comparable exterior surface of the comparable structure.

### Coating Kits

In another embodiment, a kit of parts is provided. The kit comprises a pre-fabricated, and sometimes commercially available, tent having a tent structure. The kit further comprises a coating structure, including but not limited to a one-sided coated tarp or a two-sided coated tarp, wherein the coated side of the tarp comprises a coating composition. The coating composition comprises a coating matrix and an effective amount of flaked borosilicate glass. The kit may further comprise a filler system, comprising at least one inert gas source and at least one desiccant. In some embodiments, the filler system is configured to fill a space between the tent structure and the coating structure. In some embodiments, the space between the tent structure and the coating structure is configured to form a sealed system once assembled. In such embodiments, space between the tent structure and the coating structure may be inflated by the user with an external gas source, for instance a foot-operated air pump, a compressed gas source, a compressor, or other mechanical means. In other embodiments, the space between the tent structure and the coating structure may be inflated by an automated system. In still other embodiments, the space between the tent structure and the coating structure is configured to receive an inflatable inner tube, comprising at least one of a gas and a desiccant, into the space between the tent structure and the coating structure.

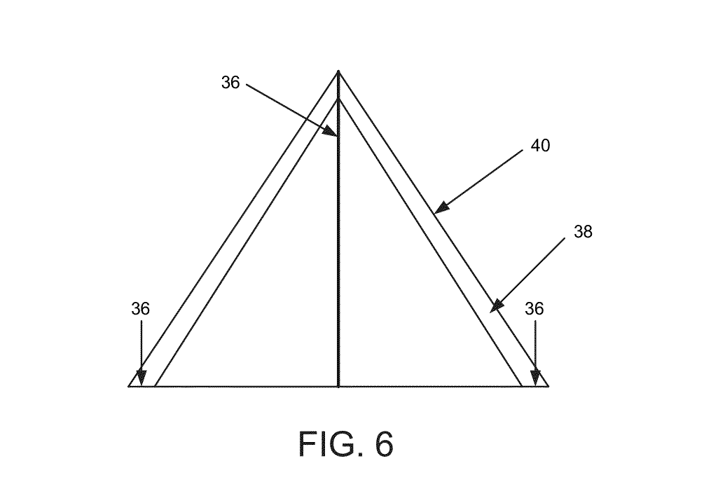

FIG. 6 shows an embodiment of a kit comprising a commercial tent (34) with existing structural components (36) that may be connected to material layer (40). The material layer (40) may be supported by the structural components (36) of the commercial tent (34), providing an appropriate separation distance between the exterior surface of the tent (34) and the material layer (40). The space between the exterior surface of the tent (34) and the material layer (40) may be then filled with a desiccant (16) and a gas (18). In some embodiments, an inner tube (38) may be inserted between the exterior surface of the tent (34) and the material layer (40). In some embodiments, the inner tube (38) is pre-filled with a desiccant (16) and/or a gas (18). In still other embodiments, the inner tube (38) may be further inflated by the user with an external air source, for instance a foot-operated air pump, a compressed gas source, a compressor, or other mechanical means. In still other embodiments, the material layer (40) may be affixed directly to the structural components (36) without there being a space between the material layer (40) and the structural components (36).

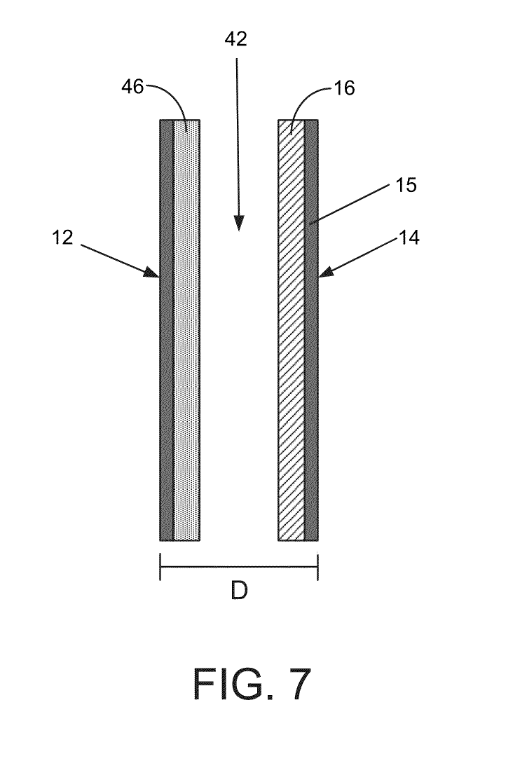

Shown in FIG. 7 is an alternate embodiment, where the kit comprises a layer (12) of a commercial tent that is coated with insulation (46). An outer cover, having an interior layer comprising a desiccant layer (16) and a material layer (15) comprising the coating composition (14), may be connected to the commercial tent such that the coated surface of the material layer (15) faces away from the commercial tent and is optionally separated by a distance D. In such an embodiment, gas may then be inserted directly into the void (42) once the material layer (15) has been properly secured to the frame components of the commercial tent. Alternatively, an inflatable inner tube may be used to provide a gap of air between the commercial tent and the material layer (15).

In some embodiments, the filler system further comprises an inner tube that is configured to contain at least one gas and at least one desiccant. In some embodiments, the inner tube may be configured for insertion between the tent structure and the material layer. In still other embodiments, at least one additional gas may be added to the inner tube, possibly for inflation of the inner tube to a suitable size to fill the space between the tent structure and the coating structure.

In another embodiment, a method for assembling a tent covered with a thermal layer is provided. The method comprises erecting a tent structure and covering the tent structure with the thermal layer. The thermal layer comprises a coating composition, wherein the coating composition comprises a coating matrix and an effective amount of flaked borosilicate glass. The space between the tent structure and the thermal layer is then filled with at least one gas and/or at least one desiccant. In some embodiments, the step of filling the space between the tent structure and the thermal layer may be accomplished by inserting an inner tube, comprising the at least one gas and/or the at least one desiccant, between the tent structure and the thermal layer.

### Surface Cooling Methods

In an embodiment, a method for cooling a surface is provided. The method includes applying a coating composition to the surface to form a coated surface. The coating composition includes a quantity of flaked borosilicate glass and a coating matrix. Upon exposure of the coated surface to sunlight or heat, the quantity of flaked borosilicate glass in the coating composition is effective such that the coated surface exhibits a cooler temperature than a temperature of a comparable uncoated surface, similarly exposed to sunlight or heat, but that does not comprise the coating composition.

In certain embodiments, exposure to sunlight or heat means exposure to solar radiation. In some embodiments, the surface may be directly exposed to solar radiation. In other embodiments, the surface may be indirectly exposed to solar radiation.

The coating compositions used to cool the surfaces, including the degree of surface cooling, the amount of solar reflectance, and the quantity of flaked borosilicate glass in the coating compositions are the same as described above. The coating compositions used to cool the surfaces may also comprise any of the other properties described above for coating compositions comprising flaked sodium borosilicate glass.

It should be apparent that the foregoing relates only to the preferred embodiments of the present invention and that numerous changes and modifications may be made herein without departing from the spirit and the scope of the invention as defined by the following claims and equivalents thereof.

We claim:

1. A surface coated with a coating composition to form a coated surface, the coating composition comprising:
a coating matrix; and
a quantity of flaked borosilicate glass;
wherein, upon exposure of the coated surface to sunlight or heat, the quantity of flaked borosilicate glass in the coating composition is effective such that the coated surface exhibits a cooler temperature than a temperature of a comparable uncoated surface, similarly exposed to sunlight or heat, but that does not comprise the coating composition.

2. The surface of claim 1, wherein the temperature of the coated surface is at least about 5° F. cooler than the temperature of the comparable uncoated surface.

3. The surface of claim 1, wherein upon exposure to sunlight or heat, the coated surface has a radiative emittance in a wavelength range of about 15 μm to about 1000 μm to emit thermal energy in the wavelength range.

4. The surface of claim 1, wherein the quantity of flaked borosilicate glass in the coating composition is in the range of about 5 wt % to about 50 wt % of the coating composition.

5. The surface of claim 1, wherein the coating composition has a thickness in the range of about 1 mil to about 8 mils.

6. The surface of claim 1, wherein the surface comprises a roofing shingle.

7. The surface of claim 1, wherein the surface comprises a granule of a roofing shingle.

8. The surface of claim 1, wherein the surface comprises a carbon nanotube.

9. A method for cooling a surface, the method comprising:
applying a coating composition to the surface to form a coated surface, wherein the coating composition comprises a quantity of flaked borosilicate glass and a coating matrix; and
exposing the coated surface to sunlight or heat;
wherein, upon exposure of the coated surface to sunlight or heat, the quantity of flaked borosilicate glass in the coating composition is effective such that the coated surface exhibits a cooler temperature than a temperature of a comparable uncoated surface, similarly exposed to sunlight or heat, but that does not comprise the coating composition.

10. The method of claim 10, wherein the temperature of the coated surface is at least about 5° F. cooler than the temperature of the comparable uncoated surface.

11. The method of claim 10, wherein upon exposure to sunlight or heat, the coated surface has a radiative emittance in a wavelength range of about 15 μm to about 1000 μm to emit thermal energy in the wavelength range.

12. The method of claim 10, wherein the quantity of flaked borosilicate glass in the coating composition is in the range of about 5 wt % to about 50 wt % of the coating composition.

13. The method of claim 10, wherein the coated surface is directly exposed to solar radiation.

14. The method of claim 10, wherein the coated surface is indirectly exposed to solar radiation.

15. A structure comprising:
a structural substrate comprising an exterior surface;
a material layer affixed to the exterior surface of the structural substrate, the material layer comprising a first surface at least partially coated with a coating composition, the coating composition comprising a quantity of flaked borosilicate glass;
wherein, upon exposure of the at least partially coated first surface to sunlight or heat, the quantity of flaked borosilicate glass in the coating composition is effective such that the at least partially coated first surface exhibits a cooler temperature than a temperature of a surface of a comparable uncoated material layer, similarly exposed to sunlight or heat, but that does not comprise the coating composition.

16. The structure of claim 16, wherein the temperature of the at least partially coated first surface is at least about 5° F. cooler than the temperature of the surface of the comparable uncoated material layer.

17. The structure of claim 16, wherein upon exposure to sunlight or heat, the coated surface has a radiative emittance in a wavelength range of about 15 μm to about 1000 μm to emit thermal energy in the wavelength range.

18. The structure of claim 16, wherein the quantity of flaked borosilicate glass in the coating composition is in the range of about 5 wt % to about 50 wt % of the coating composition.

19. The structure of claim 16, wherein the structural substrate comprises a wall structure or a tent structure.
